(19) United States
(12) Patent Application Publication
(10) Pub. No.: US 2002/0159592 A1
(43) Pub. Date: Oct. 31, 2002

(54) Content reception terminal and recording medium

(76) Inventors: Hideki Matsushima, Hirakata (JP); Katsumi Tokuda, Mino (JP); Masayuki Kozuka, Arcadia, CA (US)

Correspondence Address: WENDEROTH, LIND & PONACK, L.L.P., 2033 K STREET N. W., SUITE 800, WASHINGTON, DC, 20006-1021, US

(21) Appl. No.: 10/018,359

(22) PCT Filed: May 11, 2001
(86) PCT No.: PCT/US01/15439

(30) Foreign Application Priority Data
May 11, 2000 (US) 09/568551

(51) Int. Cl. H04N 7/167

(52) U.S. Cl. 380/201

(57) ABSTRACT

An information reception unit (123) of a content reception terminal apparatus (102) receives encrypted content which includes header information showing a type of application. An access unit (127) has a storage reference table (400)which includes a plurality of sets, each set made up of header information and a storage folder name. The access unit (127) receives the encrypted content from the information unit (123), extracts the header information from the encrypted content, extracts a set having the same header information as the extracted header information from the storage reference table (400), and retrieves the storage folder name included in the extracted set. Next, the access unit (127) writes the received encrypted content to a folder shown by the extracted storage folder name.

### TECHNICAL FIELD

The present invention relates to a content reception technique for receiving a digital work and writing the received digital work to a recording medium.

### BACKGROUND ART

Recently, with the spread of the Internet, distribution through the Internet of digital content for a charge and non-packaged digital content is increasing.

The infrastructure for distribution of non-packaged digital content is not limited to the Internet, but can take various forms such as a mobile telephone network, or BS digital broadcasting which began in Japan in late 2000.

In BS (broadcast satellite) digital broadcasting and cable television (CATV) in Japan, for instance, a terminal apparatus call ed a Set Top Box (STB) is used connected to a home television. The STB receives digital content from, for instance, the BS digital broadcasting system or the CATV system, displays the received content on the home television, or records the received digital content on a recording medium. The recorded content is, for instance, displayed, output or replicated.

Here, encrypted content encrypted using an encryption key is recorded on the recording medium in order to prevent the digital content from being used illegally against the author's will.

Furthermore, digital content is classified into a plurality of application categories such as movies and music. The recording medium had a folder for each application and writes digital content belonging to a particular type of application to the relevant folder.

In this way, various types of digital content are encrypted and written to the recording medium using one common encryption key, but if the encryption key of the encryption content belonging to one application is known illegally, a problem arises that all the encrypted content belonging to other types of applications are decrypted illegally using the decrypted encryption key.

### DISCLOSURE OF THE INVENTION

The present invention comes about in view of such problems. The object of the present invention is to provide a content reception terminal apparatus, a content reception method, a content reception program, and a recording medium recording the content reception program for receiving and writing electronic content to a recording medium so encrypted content belonging to an application is not deciphered illegally even when an encryption key used when encrypting a content belonging to another application is known illegally.

In order to achieve the above-described object, the present invention is a content reception terminal apparatus for writing a digital work received from an external distribution apparatus to a portable recording medium which has a storage area. The content reception apparatus includes a reception unit operable to receive an encrypted digital work encrypted using a content key and the content key from the distribution apparatus, the encrypted digital work belonging to one of a plurality of categories, and all encrypted digital works belonging to a same category being digital works made up of a same logical data structure, a distinguishing unit operable to distinguish a category to which a received encrypted work belongs, a key encryption unit operable to encrypt the received content key using a key unique to the distinguished category, and generate the encrypted content key, and a writing unit operable to write the received encrypted digital work and the generated encrypted content key to an area assigned to the distinguished category in the storage area of the recording medium.

According to this construction, the content key of each application is encrypted using a key unique to the particular application and written to the recording medium, therefore even if the content key is known illegally, the encrypted content key of other applications recorded on the recording medium cannot be correctly decrypted using the illegally known unique key. As a result, encrypted content of other applications cannot be illegally deciphered.

Here, the encrypted digital work may include type information showing the category, the reception unit receiving the encrypted digital work which includes the type information showing the category, the distinguishing unit extracting the type information from the encrypted digital work, and distinguishing the category using the extracted type information, the key encryption unit using a key unique to and corresponding to the extracted type information. The writing unit may include a table storage unit operable to store in correspondence, for each category, type information showing the category, and an area name showing an area in the storage area to which the category is assigned, an area name extraction unit operable to extract the area name stored in correspondence with the extracted type information from the table storage unit, and an access unit operable to write the received encrypted digital work to an area in the recording medium shown by the extracted area name.

According to this construction, the encrypted digital work is written to an area of the recording medium assigned to the application using the type information showing the type of application included in the received encrypted digital work, therefore, a different area for writing each application to can be specified.

Here, the recording medium may further include an apparatus authentication unit operable to authenticate a validity of the content reception apparatus, the storage area including a authentication area. The content reception terminal apparatus may further include a medium authentication unit operable to authenticate a validity of the recording medium, and the writing means may write the encrypted content key to the area assigned to the distinguished category in the authentication area, when mutual authentication by the apparatus authentication unit and the recording medium authentication unit succeeds.

According to this construction, when mutual authentication between the content reception terminal apparatus and the recording medium succeeds, the encrypted content key is written to the area assigned to the particular application in the authentication area, therefore, an encrypted content key of a different application cannot be retrieved, strengthening the protection of the work.

Here, the recording medium may further store type information specifying a type of the recording medium. The content reception terminal apparatus may further include a type information storage unit for storing type information showing a type of a recording medium permitting writing by the content reception terminal, a retrieval unit operable to retrieve type information from the recording medium, and a match judgement unit operable to judge whether the recorded type information and the retrieved type information match. The writing unit may prevent the writing when the match judgement unit judges the recorded type information and the retrieved type information not to match.

According to this construction, the content reception terminal apparatus prevents writing of information to an impermissible recording medium, strengthening protection of the work.

### BRIEF DESCRIPTION OF DRAWINGS

FIG. 1 is a block diagram showing the structure of the content reception system 1;

FIG. 2 is a structural drawing showing the data structure of the content list 700;

FIG. 3 is a structural drawing showing the data structure of the content key management table 900;

FIG. 4 is a structural drawing showing the data structure of the encrypted content;

FIG. 5 is a structural drawing showing the data structure of the recording area 131 of the recording medium;

FIG. 6 is a structural drawing showing the data structure of the storage reference table 400;

FIG. 7 is a display screen displayed on the display apparatus;

FIG. 8 is a flowchart showing the content list display operation;

FIG. 9 is a flowchart showing the encrypted content acquisition operation;

FIG. 10 and FIG. 11 are flowcharts showing the write operation to the recording medium;

FIG. 12 is a block diagram showing the structure of the content reception system la;

FIG. 13 is a flowchart showing the content acquisition operation.

### BEST MODE FOR CARRYING OUT THE INVENTION

1. Content Reception System 1

The following explains a content reception system 1 of a first mode for carrying out the present invention.

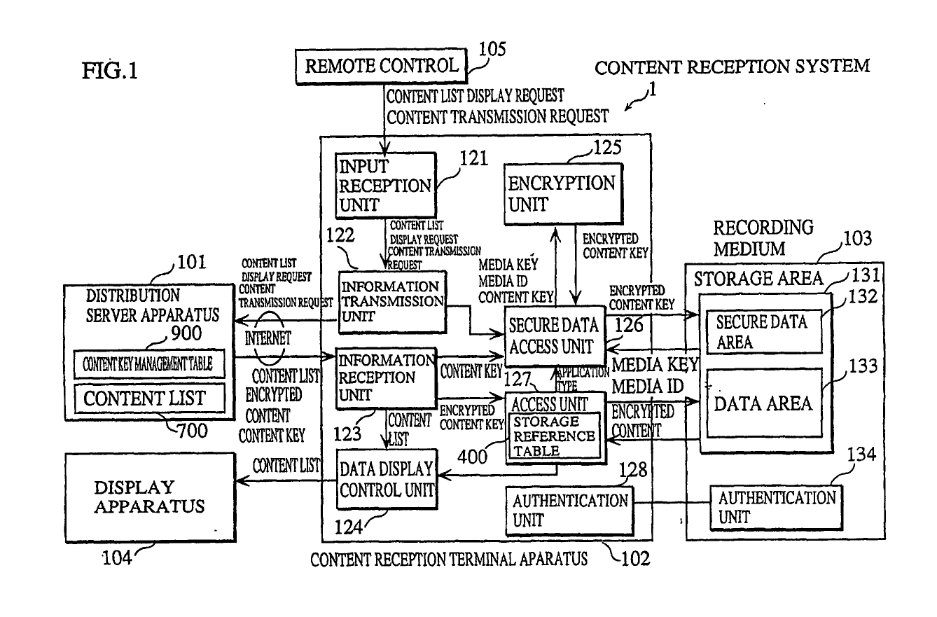

The content reception system 1, as shown in FIG. 1, includes a distribution server apparatus 101, a content reception terminal apparatus 102, a recording medium 103, a display apparatus 104, and a remote control 105.

The distribution server apparatus 101 and the content reception terminal apparatus 102 are connected via the Internet. The distribution server apparatus 101 records a plurality of digital works such as music, movies, game software, and still images, and a list of the digital works. The distribution server apparatus 101 sends the list and a number of digital works to the content reception terminal apparatus 102 via the Internet in response to a request from the content reception terminal apparatus 102.

The content reception terminal apparatus 102, by operations of the remote control 105 by the user, receives the list and displays the list on the display apparatus 104. In addition, the content reception terminal apparatus 102 receives digital work and writes the received digital work to the recording medium 103 according to the operations of the remote control 105.

1.1 Distribution Server Apparatus 101

The distribution server apparatus 101 is, specifically, a computer system including a microprocessor, a ROM, a RAM, a hard disk unit, a display unit, a keyboard, a mouse, and a LAN connection unit. Computer programs are stored in the RAM and the hard disk unit. The apparatus accomplishes its functions with operations by the microprocessor following the computer programs.

(1) Content List 700 and Content Key Management Table 900

The distribution server apparatus 101 stores a content list 700 and a content key management table 900 in the hard disk unit.

### Content List 700

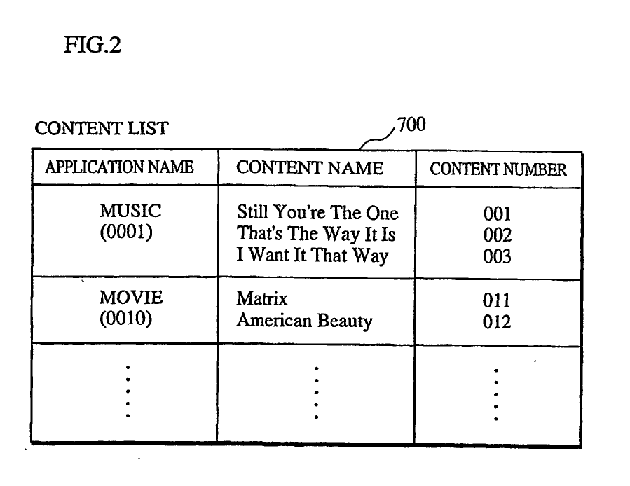

The content list 700, as shown as an example in FIG. 2, includes a plurality of sets, each set made up of a content name and a content number used for distinguishing each of a plurality of digital works such as music and movies. Each set corresponds to one digital work. Each digital work is classified into one of a plurality of types of applications such as movies and music. The content list 700, in addition, includes an application name showing the application into which the digital work corresponding to a set is classified, in correspondence with each set.

Each digital work has a data structure based on a standardized data format. Here, a plurality of encrypted digital works belonging to the same application are composed from the same logical data structure.

Please note that the data structure of information written to the recording medium has a two-layer hierarchical structure; a physical layer and an application layer. The physical layer is based on the physical characteristics of the recording medium. The application layer shows the logical data structure of the information. The above-mentioned “same logical data structure” refers to the application layer.

Here, the content name is a title for identifying a digital work, and includes a notation identifiable by people. Furthermore, the content number is a number for identifying a digital work.

Please note that in order to aid understanding names such as “music” and “movie(s)” are used as application names in FIG. 2 but in reality codes such as “0001” and “0010” are used to distinguish applications such as “music” and “movie(s)”.

### Content Key Management Table 900

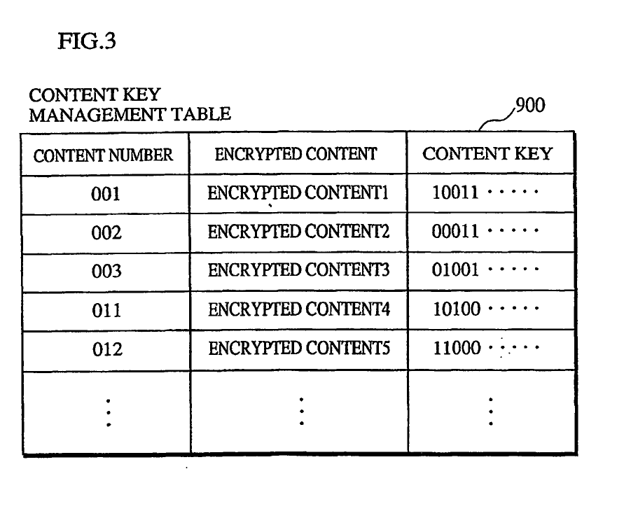

The content key management table 900, as shown as an example in FIG. 3, includes a plurality of sets, each set made up of a content number, an encrypted content, and a content key. Each set corresponds to a digital work.

The content number, as explained above, is a number for identifying a digital work.

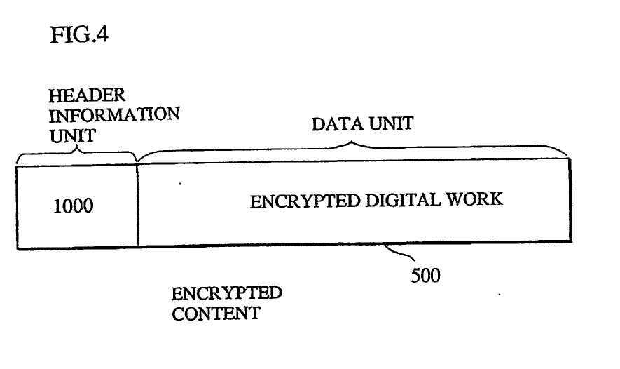

The encrypted content, as shown in FIG. 4, is made up of a header information unit and a data unit. The application name showing the application into which the particular digital work is classified is included in the header information unit. Furthermore, an encrypted digital work generated by applying an encrypted algorithm to the relevant digital work using an encryption key is included in the data unit. Here, the encryption algorithm is DES (Data Encryption Standard). Please note that an explanation of DES will be omitted as DES is well known.

The content key is the encryption key used when the encrypted digital work is encrypted, and is 56 bits in length.

(2) Other Structure

The distribution server apparatus 101 receives a content list transmission request and a content transmission request from the content reception terminal apparatus 102 via the internet. Here, a content number which distinguishes a digital work is included in the content transmission request.

The distribution server apparatus 101, on receiving the content list transmission request, retrieves the content list 700, and transmits the retrieved content list via the Internet to the content reception terminal apparatus 102 which is the origin of the request.

The distribution server apparatus 101, on receiving the content transmission request, extracts the content number from the received content transmission request, extracts the set containing the same content number as the extracted content number from the content key management table 900, and transmits the encrypted content and the content key contained in the extracted set via the Internet to the content reception terminal apparatus 102 which is the origin of the request.

Here the transmission of the content key is performed using PGP (Pretty Good Privacy) which allows for secure transmission and reception.

1.2 Remote Control 105

The remote control 105 includes a power button, number buttons, and a plurality of operation buttons on the top surface. Each button is operated by the user. The remote control 105, when each button is operated, transmits requests corresponding to the type of operation to the content reception terminal apparatus 102.

The requests include a content list display request showing a request to display a content list, and a content transmission request showing a request to transmit content.

1.3 Recording Medium 103

The recording medium 103 is a portable semiconductor medium, and, as shown in FIG. 1, includes a recording area 131 and a authentication unit 134.

(1) Authentication Unit 134

The authentication unit 134 authenticates between itself and the authentication unit 128 of the content reception unit 102 whether each thereof is valid using a challenge-response type authentication procedure when the recording medium 103 is loaded in the content reception unit 102 and when a) the content reception apparatus 102 writes to the recording medium, and b) the content reception apparatus 102 retrieves information from the recording medium 103.

Here an explanation of the challenge-response type authentication procedure will be omitted as such a procedure is well known.

Only when the authentication unit 134 authenticates the content reception apparatus 102 to be a valid apparatus and the authentication unit 128 of the content reception apparatus 102 authenticates the recording medium 103 to be a valid apparatus, does the recording medium 103 permit the content reception apparatus 102 to write information to the secure data area 132 of the recording medium 103, and to retrieve information from the secure data area 132 of the recording medium 103.

(2) Recording Area 131

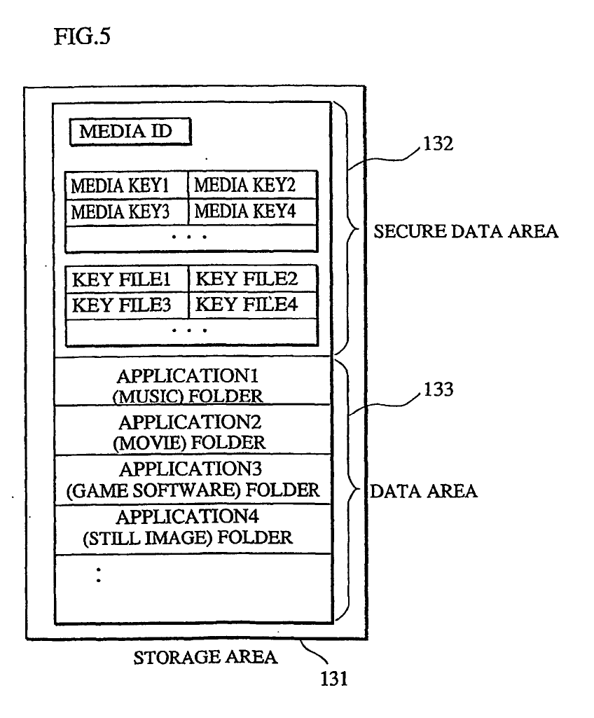

The recording area 131, as shown in FIG. 5, includes a secure data area 132 and a data area 133.

### Secure Data Area 132

The secure data area 132 is an area whose access is permitted when the device authentication between the recording medium 103 and the content reception apparatus 102 succeeds.

The secure data area 132 stores a media ID, a plurality of media keys, and a number of key files equal to the number of media keys.

The media ID is an identifier unique to the recording medium 103. When the recording medium 103 is manufactured, a different media ID for each recording medium is written to the secure area 132. The media ID is 64 bits in length.

Each media key is recorded in correspondence with an application, and is a key assigned to an application. Each media key is 56 bits in length.

Each key file includes an area corresponding to an application.

### Data Area 133

The data area 133 includes folders corresponding to applications. Each folder is an area of a section of the data area. Each folder is shown by a folder name. The data area 133 is an area which is accessible whether or not the authentication succeeds.

1.4 Content Reception Terminal Apparatus 102

The content reception terminal apparatus 102 is a set top box (STB), and as shown in FIG. 1, includes an input reception unit 121, an information transmission unit 122, an information reception unit 123, a data display control unit 124, an encryption unit 125, a secure data access unit 126, an access unit 127, and a authentication unit 128.

The content reception terminal apparatus 102 is, specifically, in the same way as the distribution server unit 101, a computer system including a microprocessor, a ROM, a RAM, a hard disk unit, and a LAN connection unit. Computer programs are stored in the RAM and the hard disk unit. The apparatus accomplishes its functions by operation with the microprocessor following the computer programs.

(1) Input Reception Unit 121

The input reception unit 121 receives a content list display request and a content transmission request transmitted from the remote control 105, and on the reception of each request outputs the requests to the information transmission unit 122.

(2) Information Transmission Unit 122

The information transmission unit 122 is connected to the distribution server apparatus 101 via the Internet.

The information transmission unit 122 receives the content list display request and a content transmission request from the input reception unit 121, and on reception of a request, transmits the request to the distribution server apparatus 101 via the Internet.

(3) Information Reception Unit 123

The information reception unit 123 is connected to the distribution server apparatus 101 via the internet.

The information reception unit 123 receives the content list, the encrypted content, and the content key from the distribution server 101.

Here, the reception of the content key is performed using PGP (Pretty Good Privacy) which allows for secure transmission and reception.

The information reception unit 123, on reception of the content list, outputs the received content list to the data display control unit 124.

The information reception unit 123, on reception of the encrypted content and the content key, outputs the received encrypted content to the access unit 127, and outputs the received content key to the secure data access unit 126.

(4) Data Display Control Unit 124

The data display control unit 124 receives the content list from the information reception unit 123, converts the received content list to a video signal of the display format, and outputs the video signal to the display apparatus 104.

(5) Authentication Unit 128

The authentication unit 128 authenticates between itself and the authentication unit 134 of the recording medium 103 whether each thereof is valid using a challenge-response type authentication procedure when the recording medium 103 is loaded in the content reception unit 102 and when a) the content reception apparatus 102 writes to the recording medium, and b) the content reception apparatus 102 retrieves information from the recording medium 103.

Here an explanation of the challenge-response type authentication procedure will be omitted as such procedures are well known.

Only when the authentication unit 128 authenticates the recording medium 103 to be a valid apparatus and the authentication unit 134 of the recording medium 103 authenticates the content reception apparatus 102 to be a valid apparatus, does the recording medium 103 permit the content reception apparatus 102 to write information to the secure data area 132 of the recording medium 103, and to retrieve information from the secure data area 132 of the recording medium 103.

(6) Access Unit 127

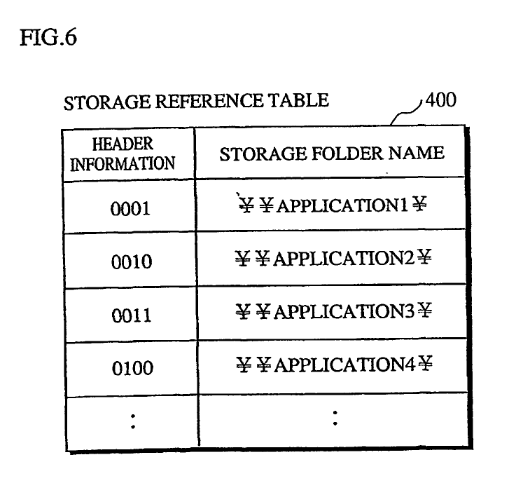

The access unit 127, as shown as an example in FIG. 6, has a storage reference table 400.

The storage reference table 400 includes a plurality of sets, each set made up of header information and a storage file name. The header information, as shown in the previous explanation, is information showing the type of application. The folder name is a name showing a folder in the data area 133 of the recording medium 103.

The access unit 127 receives the encrypted content from the information reception unit 123. The access unit 127, on receiving the encrypted content, extracts the header information from the received encrypted content, extracts the set having the same header information as the extracted header information from the storage reference table 400, and retrieves the storage folder name included in the extracted set. Next, the access unit 127 writes the received encrypted content to the folder in the data area 133 of the recording medium 103 shown by the extracted storage folder name.

Furthermore, the access unit 127 outputs extracted header information as a type showing an application to the secure data access unit 126.

(7) Secure Data Access Unit 126

The secure data access unit 126 receives the content key from the information reception unit 123, and receives the type of application from the access unit 127.

Furthermore, the secure data access unit 126 retrieves the media ID recorded in the secure data area 132 of the recording medium 103. In addition, the secure data access unit 126 retrieves the media key stored in the secure data area 132 of the recording medium 10-3 in correspondence with the received type of application.

Next, the secure data access unit 126 outputs the retrieved media ID, the retrieved media key, and the received content key, to the encryption unit 125.

Next, the secure data access unit 126 receives an encrypted content key from the encryption unit 125, and writes the received encrypted content key to the key file in the secure data area 132 of the recording medium 103 corresponding to the received type of application.

In this way, the secure data access unit 126 only permits retrieval of the key file corresponding to the application when mutual authentication between the content reception terminal apparatus 102 and the recording medium 103 succeeds.

(8) Encryption Unit 125

The encryption unit 125 receives the media ID, the media key and the content key from the secure data access unit 126.

Next, the encryption unit 125 applies the encryption algorithm according to DES to the received content key, using the media ID and the media key, generates an encrypted content key, and outputs the generated encrypted content key to the secure access unit 126. Here the generated encrypted content key is 56 bits in length.

1.5 Display Apparatus 104

The display apparatus, specifically, includes a display unit such as a cathode ray tube.

The display apparatus 104 receives a video signal formed based on the content list from the data display control unit 124, and displays the received video signal.

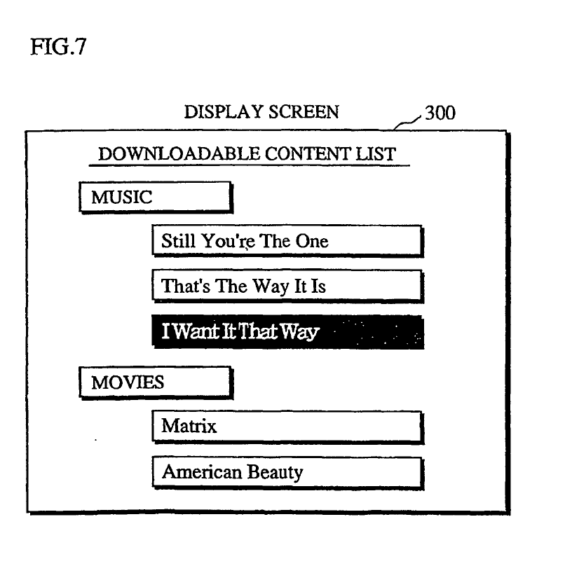

An example of a screen that the display unit 104 displays is shown in FIG. 7. The display screen 300in FIG. 7 shows a list of content that is downloadable from the distribution server apparatus 101. Titles showing a plurality of works for each application such as music and movies are displayed.

1.6 Operations of Content Reception System 1

From amongst the operations of the content reception system 1, the operation for displaying a content list and the operation for acquiring content will be explained below.

(1) Operation for Displaying a Content List

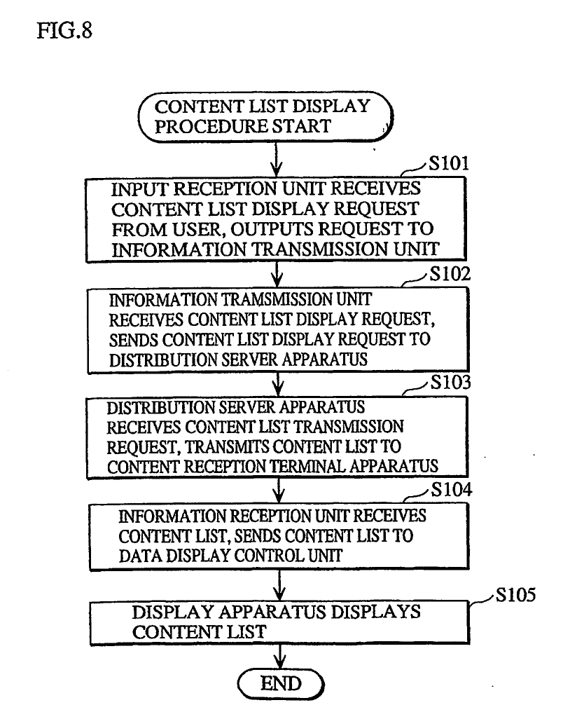

The operation for displaying a content list will be explained using the flowchart shown in FIG. 8.

The input reception unit 121 receives a content list display request from the user, and outputs the request to the information transmission unit 122 (step S101). The information transmission unit 122 receives the content list display request and transmits a content list transmission request to the distribution server apparatus 101 (step S102). Next, the distribution server apparatus 101 receives the content list transmission request, and transmits the content list to the content reception terminal apparatus 102 (step S103) The information reception unit 123 receives the content list, and outputs the content list to the data display control unit 124 (step S104). The display apparatus displays the content list (step S105).

(2) Operation for Acquiring Content

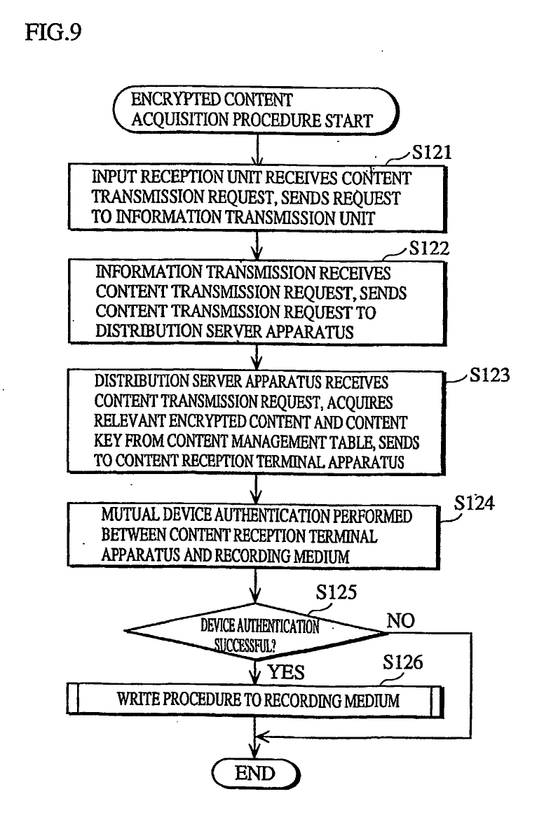

The operation for acquiring content will be explained using the flowchart shown in FIG. 9.

The input reception unit 121 receives a content transmission request, and outputs the content transmission request to the information transmission unit 122 (step S121). The information transmission unit 122 receives the content transmission request, and transmits the content transmission request to the distribution server apparatus 101 (step 122). Next, the distribution server apparatus 101 receives the content transmission request, acquires the relevant encrypted content and content key from the content management table, and transmits the acquired encrypted content and content key to the content reception terminal unit 102 (step S123). The authentication unit 128 and the authentication unit 134 perform mutual device authentication between the content reception terminal apparatus 102 and the recording medium 103 (step S124), and, when the equipment authentication succeeds (YES at step S125), a writing procedure to the recording medium 103 is performed (step S126), and the procedure ends.

When the equipment authentication does not succeed (NO at step S125) the procedure ends.

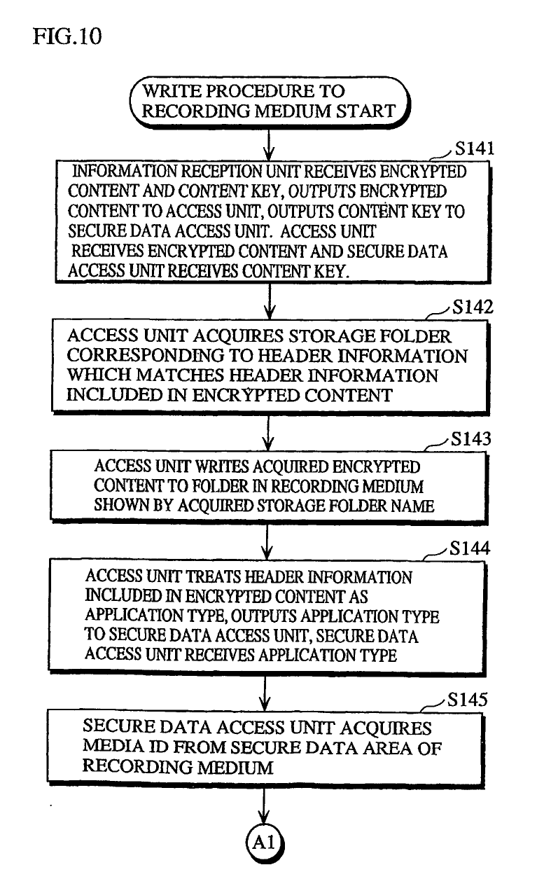

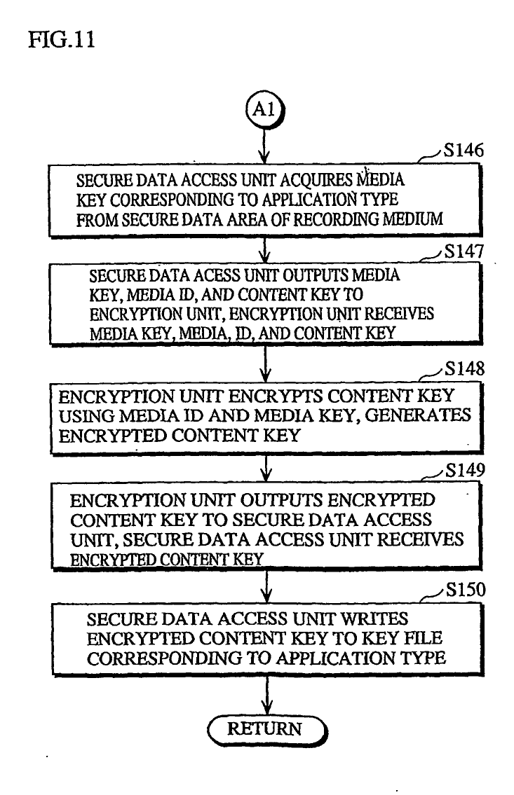

Next details of the operation of the writing procedure to the recording medium 103 at step S126 will be explained using the flowcharts in FIG. 10 and FIG. 11.

The information reception unit 123 receives the encrypted content and the content key, outputs the encrypted content to the access unit 127, and outputs the content key to the secure data access unit 126. The access unit 127 receives the encrypted content, and the secure data access unit 126 receives the content key (step S141).

Next, the access unit 127 acquires a storage folder name corresponding to the header information that matches the header information included in the encrypted content from the storage reference table (step S142), and in addition the access unit 127 writes the acquired encrypted content to the folder in the recording medium 103 shown by the acquired storage folder (step S143).

Next, the access unit 127 treats the header information included in the encrypted content as the type of application, outputs the type of application to the secure data access unit 126, and the secure data access unit 126 receives the header information as the type of application (step S144).

The secure data access 126 acquires the media ID from the secure data area 132 of the storage medium 103 (step S145), then acquires the media key corresponding to the type of application from the secure data area 132 of the recording medium 103 (step S146), outputs the media key, the media ID, and the content key to the encryption unit 125, and the encryption unit 125 receives the media key, the media ID, and the content key (step S147).

Next, the encryption unit 125 encrypts the content key using the media ID and the media key, and generates the encrypted content key (step S148). The encryption unit 125 outputs the generated encrypted content key to the secure data access unit 126, and the secure data access unit 126 receives the encrypted content key (step S149).

Next, the secure data access unit 126 writes the encrypted content key to the key file which corresponds to the type of application (step S150).

1.7 Summary

As explained above, the information reception unit 123 of the content reception terminal apparatus 102 receives encrypted content which, includes header information showing the type of application. The access unit 127 has a storage reference table 400 which includes a plurality of sets, each made up of header information and a storage folder name. The access unit 127 receives encrypted content from the information reception unit 123, extracts the header information from the received encrypted content, extracts the set which has the same header information as the extracted header information from the storage reference table 400, and retrieves the storage folder name included in the extracted set. Next, the access unit 127 writes the received encrypted content to the folder in the data area 133 of the recording medium 103 shown by the retrieved storage folder name.

In this way, the content reception terminal apparatus 102 distinguishes the application of the content by the information included in the received encrypted content, specifies the folder in the recording medium, and writes the received encrypted content to the specified folder. As a result, the content reception terminal apparatus 102 writes the received encrypted content to an appropriate folder in the recording medium.

2. Variation

A content reception system 1a will be explained as a variation of the content reception system 1.

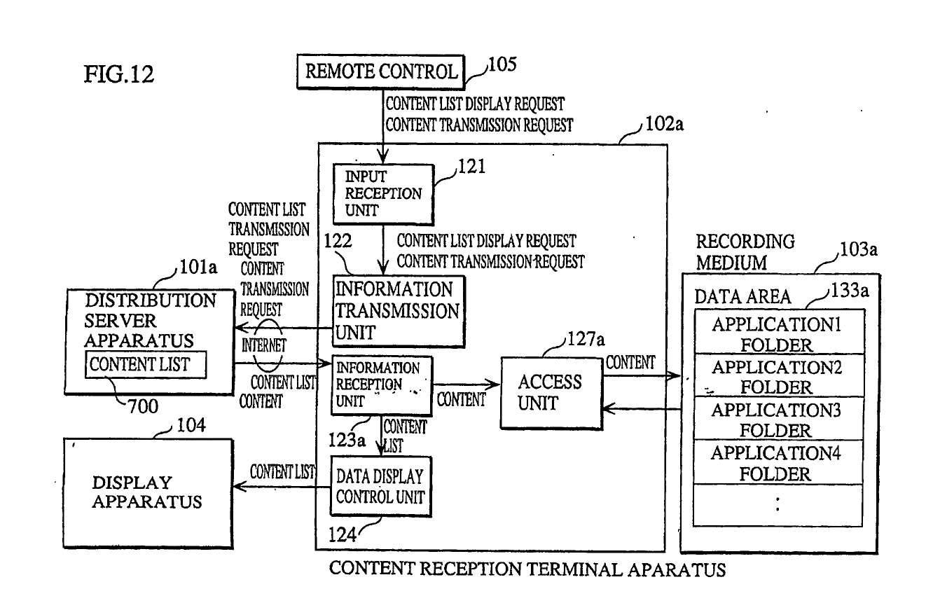

The content reception system la, as shown in FIG. 12, includes a distribution server apparatus 101a, a content reception terminal apparatus 102a, a recording medium 103a, a display apparatus 104, and a remote control 105.

The content reception system la is similar to the content reception system 1, therefore the following will focus on explaining the differences between the two systems.

2.1 Distribution Server Apparatus 101a

The distribution server apparatus 101a stores each of a plurality of content which are digital works in correspondence with a content number. Furthermore, the distribution server apparatus 101a stores the content list 700.

Here, the content includes digital works in plain text which are not encrypted. The content also includes header information. Furthermore, the content list 700 is the same as the content list 700 stored by the distribution server apparatus 101.

Furthermore, the distribution server apparatus 101a, on receiving a content transmission request, extracts a content number from the received content transmission request, retrieves the content that corresponds to the extracted content number, and transmits the retrieved content via the Internet to the content reception terminal apparatus 102a which is the origin of the transmission request.

2.2 Recording Medium 103a

The recording medium 103a, as shown in FIG. 12, has a data area 133a. The data area 133a includes folders, each folder corresponding to an application, in the same way as the data area 133. Each folder is shown by a folder name. Each folder includes an area for storing content.

2.3 Content Reception Terminal Apparatus 102a

The content reception terminal apparatus 102a, as shown in FIG. 12, includes an input reception unit 121, an information transmission unit 122, an information reception unit 123a, a data display control unit 124, and an access unit 127a.

The information reception unit 123a receives a content list and content from the distribution server apparatus 101a. The information reception unit 123a receives the content, and then outputs the received content to the access unit 127a.

The access unit 127a receives the content from the information reception unit 123a. On receiving the content, the access unit 127a extracts header information from the received content, extracts a set which has header information the same as the extracted header information from the storage referring table 400, and retrieves the storage folder name included in the extracted set. Next, the access unit 127a writes the received content to the folder in the data area 133a of the recording medium 103a shown by the extracted storage folder name.

2.4 Operations of the Content Reception System 1a

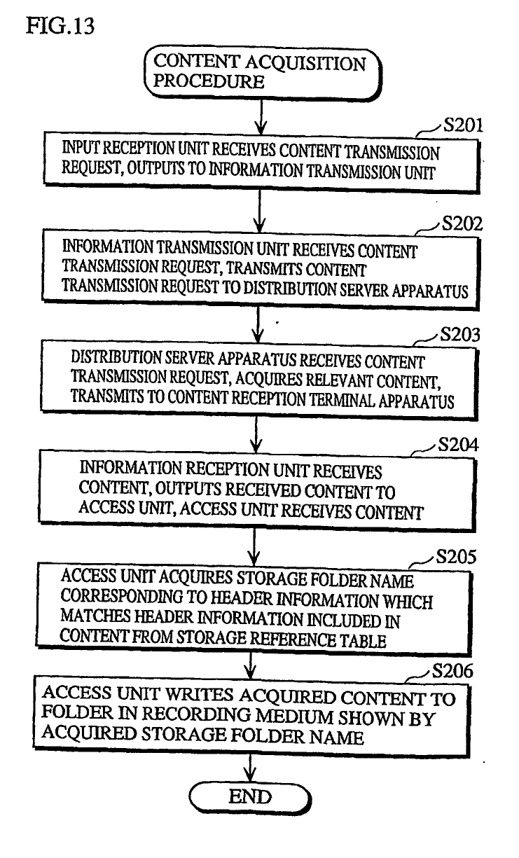

From amongst the operations of the content reception system 1a, the operation of acquiring content will be explained using the flowchart shown in FIG. 13. Please note that the operation for displaying the content list is the same as the content reception system 1 so an explanation will be omitted.

The input reception unit 121 receives a content transmission request, and outputs the request to the information transmission unit 122 (step S201). The information transmission unit 122 receives the content transmission request, and transmits the content transmission request to the distribution server apparatus 101a (step S202). Next, the distribution server apparatus 101a receives the content transmission request, acquires the relevant content, and transmits the acquired content to the content reception terminal apparatus 102a (step S203).

The information reception unit 123a receives the content, and outputs the received content to the access unit 127a, and the access unit 127a receives the content (step S204).

Next, the access unit 127a acquires the storage folder name corresponding to the header information that matches the header information included in the content (step S205). In addition, the access unit 127 writes the acquired content to the folder in the recording medium 103a shown by the acquired storage folder name (step S206).

3. Summary

As explained above, according to the recording medium of the present invention, content of a plurality of applications can be recorded, and a different key can be provided for each application.

Furthermore, according to the content reception terminal apparatus of the present invention, content acquired by a user downloading from the distribution server apparatus can be recorded in an appropriate storage area in a recording medium that has a storage area for each application. Furthermore, a key used for encrypting content can be encrypted using the recording medium media ID and media key, and recorded in a key file in the secure data area of the recording medium.

Please note that the present invention has been explained above based on a best mode for carrying out the invention, but the present invention is, of course, not limited to the above-described mode. The following cases are also included in the present invention.

(1)The content reception terminal apparatus may be, for instance, a mobile telephone, a component stereo system compliant with a network, or a personal computer.

Furthermore, the recording medium 103a may be a medium such as a DVD-RAM, a PD, a SuperDisk, an FD, or a CD-R/RW.

(2) In the above-described best mode for carrying out the invention the distribution server apparatus distributes content to the content reception terminal apparatus via the Internet, but the distribution server apparatus may distribute content via digital broadcasting, a satellite broadcasting network, or a mobile telephone network.

For example, a distribution server apparatus which may be a digital broadcast apparatus, in other words an STB, may broadcast encrypted content and a content key on a digital broadcast via a broadcast satellite or a communications satellite. The content reception apparatus may be a digital broadcast reception apparatus that receives the digital broadcast wave. The information reception unit of the content reception terminal apparatus, which may be an apparatus which receives the digital broadcast wave, may extract the encrypted digital work and the content key from the received digital broadcast wave.

(3) The content reception terminal apparatus in the above-described best mode for carrying out the invention stores information of whether the device is compliant with the downloading or writing to the recording medium of the content in the internal ROM, and the content reception terminal apparatus may be constructed not to download or write when the device is not compliant with the information.

Furthermore, information showing the type of recording medium such as information distinguishing a manufacturer who manufactured the recording medium, a marketer, or copyright management organization managing a work, or information stipulating the physical structure or the data structure of the recording medium may be recorded on the recording medium. The content reception terminal apparatus may store usable type information in the internal ROM, and the content reception terminal apparatus may retrieve the type information from the recording medium, judge whether the retrieved type information matches the type information stored internally, and not perform writing of the content to the recording medium when the type information does not match.

(4) A digital work may be, for instance, a computer program, a novel, or a program for a household appliance.

(5) In the content reception system 1, the encrypted content is encrypted according to the content key. Here, DES is used as the encrypted algorithm. This encryption method is a secret key encryption method common to an encryption key for encrypting plain text and a decryption key for decrypting an encrypted text, but a public key encryption method may be used.

Furthermore, in the encryption algorithm used in the above-described best mode for carrying out the invention, other encryption algorithms such as RSA may be used.

(6) In the above-described best mode for carrying out the invention, transmission and reception of a content key is performed using PGP, but other secure means such as SSL (Secure Socket Layer) may be used.

(7) The present invention may be the method shown in the above-described best mode for carrying out the invention. Furthermore, the present invention may be a computer program which realizes this method on a computer, and may be a digital signal composed of the computer program.

Furthermore, the present invention may be the computer program or the digital signal recorded on a computer-readable medium, for example, a floppy disk, a hard disk, a CD-ROM, an MO, a DVD, a DVD-ROM, a DVD-RAM or a semiconductor memory. Furthermore, the present invention may be the computer program or the digital signal recorded on these recording media.

Furthermore, the present invention may transmit the computer program or the digital signal through, for instance, a telecommunication line, a wireless or wired communication circuit, or a network of which the Internet is representative.

Furthermore, the present invention may be a computer system including a microprocessor and a memory, with the memory storing the computer program, and the microprocessor operating according to the computer program.

Furthermore, the present invention may be implemented on another independent computer system by recording and transferring the program or the digital signal on a recording medium, or by transferring the program of the digital signal through, for instance, the network.

(8) The above-described best mode for carrying out the invention and the above-described variations may be combined.

### Industrial Application

The present invention can be used as a reception terminal apparatus that receives digital works such as music, movies, game software, and still images distributed using, for instance, the Internet or digital broadcasting, and writes the received digital works to a recording medium.

1. A content reception terminal apparatus for writing a digital work received from an external distribution apparatus to a portable recording medium which has a storage area, comprising:
a reception unit operable to receive an encrypted digital work encrypted using a content key and the content key from the distribution apparatus, the encrypted digital work belonging to one of a plurality of categories, and all encrypted digital works belonging to a same category being digital works made up of a same logical data structure,
a distinguishing unit operable to distinguish a category to which a received encrypted work belongs,
a key encryption unit operable to encrypt the received content key using a key unique to the distinguished category, and generate the encrypted content key, and
a writing unit operable to write the received encrypted digital work and the generated encrypted content key to an area assigned to the distinguished category in the storage area of the recording medium.

2. The content reception terminal apparatus of claim 1 wherein
the encrypted digital work includes type information showing the category,
the reception unit receives the encrypted digital work which includes the type information showing the category,
the distinguishing unit extracts the type information from the encrypted digital work, and distinguishes the category using the extracted type information,
the key encryption unit uses a key unique to and corresponding to the extracted type information; and
the writing unit includes:
a table storage unit operable to store in correspondence, for each category, type information showing the category, and an area name showing an area in the storage area to which the category is assigned,
an area name extraction unit operable to extract the area name stored in correspondence with the extracted type information from the table storage unit, and
an access unit operable to write the received encrypted digital work to an area in the recording medium shown by the extracted area name.

3. The content reception terminal apparatus of claim 2 wherein
the recording medium further includes an apparatus authentication unit operable to authenticate a validity of the content reception apparatus, the storage area including a authentication area,
the content reception terminal apparatus further includes a medium authentication unit operable to authenticate a validity of the recording medium, and
the writing means writes the encrypted content key to the area assigned to the distinguished category in the authentication area, when mutual authentication by the apparatus authentication unit and the recording medium authentication unit succeeds.

4. The content reception terminal apparatus of claim 3 wherein
the recording medium further stores type information specifying a type of the recording medium;
the content reception terminal apparatus further includes:
a type information storage unit operable to store type information showing a type of a recording medium permitting writing by the content reception terminal,
a retrieval unit operable to retrieve type information from the recording medium, and
a match judgement unit operable to judge whether the recorded type information and the retrieved type information match; and
the writing unit prevents the writing when the match judgement unit judges the recorded type information and the retrieved type information not to match.

5. The content reception terminal apparatus of claim 4 wherein
the distribution apparatus broadcasts the encrypted work and the content key on a digital broadcast wave,
the content reception apparatus is a digital broadcast reception apparatus for receiving the digital broadcast wave, and
the reception unit receives the digital broadcast wave, and extracts the encrypted digital work and the content key from the received digital broadcast wave.

6. A content reception method for use with a content reception terminal apparatus for writing a digital work received from an external distribution apparatus to a portable recording medium which has a storage area, the method comprising:
a reception step for receiving an encrypted digital work encrypted using a content key and the content key from the distribution apparatus, the encrypted digital work belonging to one of a plurality of categories, and all encrypted digital works belonging to a same category being digital works made up of a same logical data structure,
a distinguishing step for distinguishing a category to which a received encrypted work belongs,
a key encryption step for encrypting the received content key using a key unique to the distinguished category, and generate the encrypted content key, and
a writing step for writing the received encrypted digital work and the generated encrypted content key to an area assigned to the distinguished category in the storage area of the recording medium.

7. A computer-readable recording medium recording a content reception program for use with a computer for writing a digital work received from an external distribution apparatus to a portable recording medium which has a storage area, the content reception program comprising:
a reception step for receiving an encrypted digital work encrypted using a content key and the content key from the distribution apparatus, the encrypted digital work belonging to one of a plurality of categories, and all encrypted digital works belonging to a same category being digital works made up of a same logical data structure,
a distinguishing step for distinguishing a category to which a received encrypted work belongs,
a key encryption step for encrypting the received content key using a key unique to the distinguished category, and generate the encrypted content key, and
a writing step for writing the received encrypted digital work and the generated encrypted content key to an area assigned to the distinguished category in the storage area of the recording medium.

8. A content reception program for use with a computer for-writing a digital work received from an external distribution apparatus to a portable recording medium which has a storage area, comprising:
a reception step for receiving an encrypted digital work encrypted using a content key and the content key from the distribution apparatus, the encrypted digital work belonging to one of a plurality of categories, and all encrypted digital works belonging to a same category being digital works made up of a same logical data structure,
a distinguishing step for distinguishing a category to which a received encrypted work belongs,
a key encryption step for encrypting the received content key using a key unique to the distinguished category, and generate the encrypted content key, and
a writing step for writing the received encrypted digital work and the generated encrypted content key to an area assigned to the distinguished category in the storage area of the recording medium.
